(19) United States
(12) Patent Application Publication
(10) Pub. No.: US 2025/0149888 A1
(43) Pub. Date: May 8, 2025

(54) VERIFICATION OF POWER DISTRIBUTION OPERATING SUITABILITY

(71) Applicant: INTERNATIONAL BUSINESS MACHINES CORPORATION, ARMONK, NY (US)

(72) Inventors: Marc Henri Coq, Hopewell Junction, NY (US); Brian Charles Tucker, Clinton Corners, NY (US); Enver Candan, Fishkill, NY (US)

(21) Appl. No.: 18/502,172

(22) Filed: Nov. 6, 2023

(51) Int. Cl. H02J 3/00

(52) U.S. Cl. CPC H02J 3/003; H02J 3/0012; H02J 2203/10; H02J 2310/16

(57) ABSTRACT

A computer-implemented method, a computer system and a computer program product verify electrical power distribution system suitability. The method includes obtaining power consumption characteristics from a computer server. The method also includes generating a test power load based on the power consumption characteristics. The method further includes identifying a power source and applying the test power load to the power source. In addition, the method includes determining a connection suitability for the power source based on a response of the power source to the test power load. Lastly, the method includes displaying the connection suitability for the power source on a device.

### BACKGROUND

Embodiments relate generally to the field of testing power distribution systems in a data center environment and, more specifically, to verifying suitability and capacity of power distribution systems through configurable load testing.

In the current technology environment, electronic equipment, including rack-mounted computer servers for purposes such as information technology, communications, automation and control, industrial applications, and other devices that may operate in a high-availability manner, may require a robust electrical power source. This robustness may be achieved through separate, redundant power supplies or connections as part of the equipment design in such operating conditions. In addition, data centers or other facilities that may house such equipment often provide electrical utility power that is sourced from two separate, independent utility grids as a way of improving the overall availability of the equipment's function, where the characteristics of both the power source and the power distribution system may be monitored and maintained.

### SUMMARY

An embodiment is directed to a computer-implemented method for verifying electrical power distribution system suitability. The method may include obtaining power consumption characteristics from a computer server. The method may also include generating a test power load based on the power consumption characteristics. The method may further include identifying a power source and applying the test power load to the power source. In addition, the method may include determining a connection suitability for the power source based on a response of the power source to the test power load. Lastly, the method may include displaying the connection suitability for the power source on a device.

In another embodiment, the method may include transmitting a notification of the connection suitability for the power source to a user.

In a further embodiment, the method may include identifying a second power source and applying the test power load to the second power source. In this embodiment, the method may also include determining that the power source and the second power source are not connected based on a second response of the second power source to the test power load and the response of the power source to the test power load. Lastly, in this embodiment, the method may include updating the connection suitability for the power source, wherein the power source is not suitable for connection.

In an additional embodiment, the generating the test power load may use a machine learning model that predicts electrical characteristics of a power supply based on known information about the power supply.

In yet another embodiment, the method may include generating a normal response for the power source to the test power load using a machine learning model that predicts electrical characteristics of a power distribution system in response to a power load.

In another embodiment, the method may include detecting that the response of the power source to the test power load is not the normal response for the power source and updating the connection suitability for the power source, wherein the power source is not suitable for connection.

In a further embodiment, the method may include displaying a model of the test power load to a user. In this embodiment, the method may also include monitoring user interactions with the model of the test power load and updating the test power load based on the user interactions.

In addition to a computer-implemented method, additional embodiments are directed to a computer system and a computer program product for verifying electrical power distribution system suitability.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process to verify electrical power distribution system suitability according to an embodiment.

### DETAILED DESCRIPTION

In the current technology environment, rack-mounted electronic equipment for purposes such as information technology (IT), communications, computer automation and control, or industrial applications, or any equipment or electronic device that may require operation in a high-availability scenario requires a robust electrical power source. Such devices may therefore be designed for such operating conditions by utilizing separate, redundant, power supplies or connections as part of the equipment. At the same time, facilities that utilize such equipment often provide electrical utility power that is sourced from two separate, independent, utility grids as a means of ensuring the overall availability of power to the equipment housed within the facility.

In such an environment, there exists the risk that equipment may not be connected properly, due to human error or other factors, resulting in a condition where the redundant utility input connections may be connected to the same utility feed rather than the facility-provided independent connections, which may defeat the purpose of providing separate redundant power and compromise the high-availability guarantees of the facility. For example, circuit breaker over-provisioning may occur, which could allow multiple loads to be connected to a single circuit breaker. Unintentional connection of multiple high-current loads to a single circuit breaker may result in fault coordination problems, unexpected losses of operational availability, and greater risk of smoke, fire, or infrastructure damage. Examples of fault conditions may include the use of a conventional utility feed paired with an online UPS feed, a possible connection to both an AC and a DC feed, a possible connection to two independent backup generators, possible connection to multiple multi-phase feeds with one having an incorrect phase rotation or a connection to three-phase derived single-phase power where the phase connections are not the same from one side to the other. It should be noted that this is not an exhaustive list of fault conditions that may be possible in a facility.

It may therefore be useful to provide a method or system to verify electrical power characteristics and determine whether a power distribution system is suitable for connection by using an active, automated test device and procedure. Such a method or system may connect to a power source under test and apply a simulated application load, or test power load, to the connected power source and measure the response of the power source to the load. The test power load may be generated by modelling one or more power supplies and mimicking the characteristics to a power distribution system. The response of the power source may be analyzed to determine a connection suitability for the power source, which may include whether the power source is separate from another power source that may be tested. Connection suitability may also include an analysis of specific characteristics of the power source, e.g., line voltage (AC or DC), Line frequency, total Harmonic Distortion and frequency spectrum content. Such a method or system may specifically improve provisioning of power distribution in equipment facilities, e.g., cloud data centers, by increasing awareness of the available electrical power within the facility, which may prevent problems related to electrical power and increase efficiency in a high-availability environment.

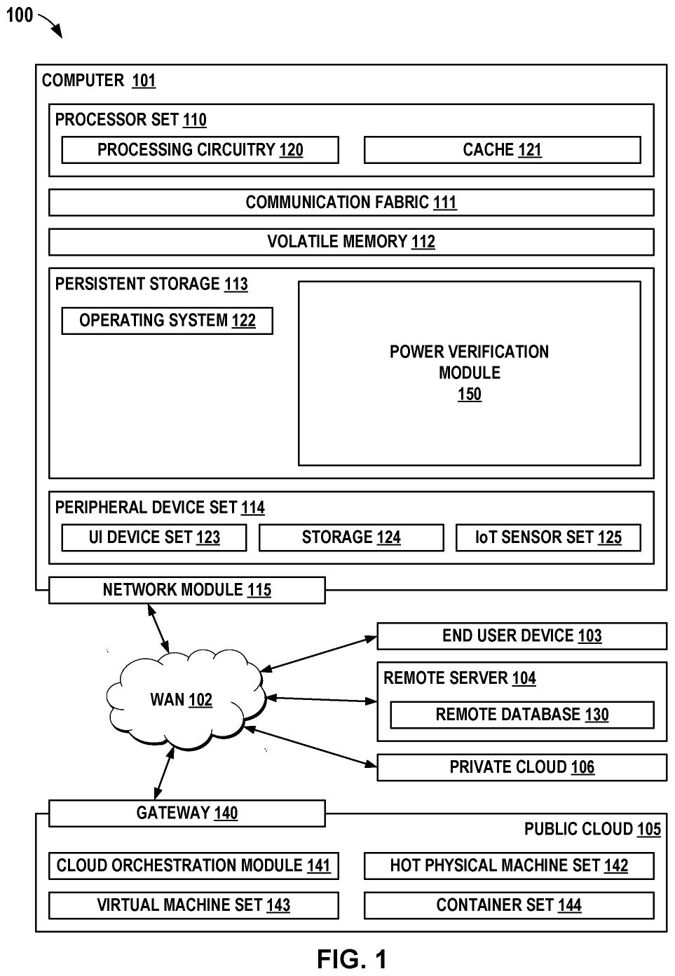

Referring to FIG. 1, computing environment 100 contains an example of an environment for the execution of at least some of the computer code involved in performing the inventive methods, such as power verification module 150. In addition to power verification module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and power verification module 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in power verification module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in power verification module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to verify electrical power distribution system suitability. In particular, the power verification module 150 may obtain power consumption characteristics for an electronics device, such as a computer server or other rack-mounted device. The power consumption characteristics may include known information about a power supply that may be available in a profile or other documentation, such as a schematic or information about specific components that may be used in the construction of the power supply, or may include specific information about a power supply, such as test results or other information. A test power load may be generated from the power consumption characteristics, such that the test power load can mimic the power consumption characteristics to a power source. The power verification module 150 may identify a power source for test, through a request from a user or automatically as part of a larger test program that may be implemented in a facility and the test power load may be applied to an identified power source. The identification and application of the test power load may be accomplished by simply choosing a power outlet and connecting the test power load physically or may alternatively be simulated through another means, such as a digital twin simulation. The response of the power source to the test power load may be measured by monitoring specific characteristics of the power source, e.g., line voltage or frequency and harmonic distortion, and a connection suitability for the power source may be determined. It should be noted that a response to a load by a power source may include detecting and measuring differences in electrical power characteristics, e.g., voltage or current or frequency content, that may be introduced by the application of the load. The determination may include classifying the power source by whether it is suitable for connection or not. It should be noted that the connection suitability may also include information about separability of power sources in a facility, such that a second power source may be tested, and the connection suitability of both power sources may depend on results of a second application of the test power load. For example, both power sources separately may be suitable for connection to the electronics device, but if a determination is made that both power sources are connected to the same power system, one or the other power source may be considered unsuitable because an electronics device may require two separate power sources to be connected for high availability. The power verification module 150 may display an indication of the connection suitability, e.g., a graphic display on a screen or indicator light, and may also include transmitting a notification to a user or facility of the connection suitability of the power source. The notification may also include automated commands that may be used to adjust the power source to cause the power source to be suitable for connection.

In an explanatory embodiment, the method or system may be implemented as test equipment for a high-availability power distribution system within a facility that provides such services. In such an embodiment, a device may be carried by a technician and/or service personnel, including as part of another mobile device, or mounted in an appropriate manner within the facility. The identification of one or more power sources for test may be done by plugging the device directly into one or more of the power sources available in the facility and indicator lights may be present on the device to display the indication of connection suitability.

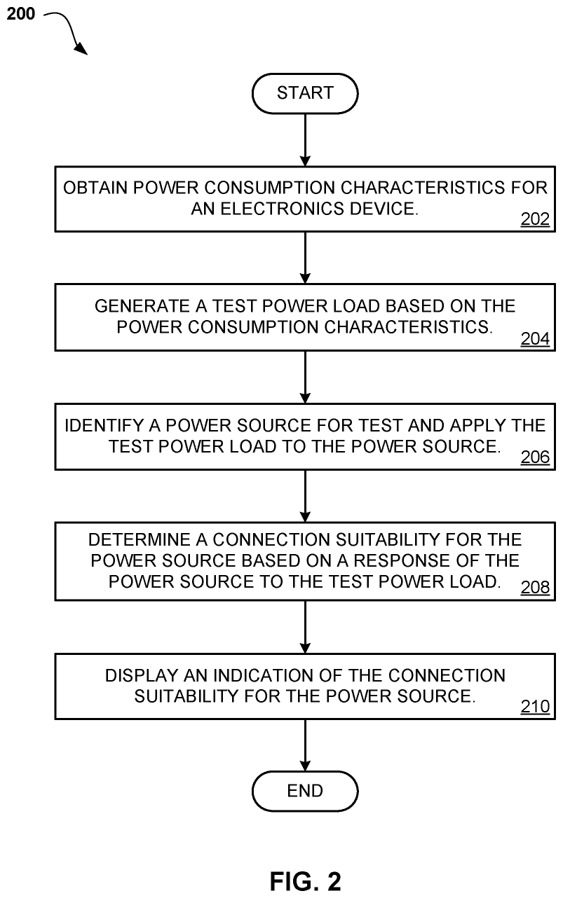

Referring to FIG. 2, an operational flowchart illustrating a process 200 that verifies electrical power distribution system suitability is depicted according to at least one embodiment. At 202, the power verification module 150 may obtain power consumption characteristics for an electronics device, e.g., a rack-mounted computer server or other equipment that may require high-availability power in an appropriate facility. The power consumption characteristics may include information from a data sheet or schematic about the power supply of the electronics device or other equipment, including data about the components used in the manufacture and assembly of the power supply. The characteristics may also include results from any prior testing of an electronics device or other equipment that may be connected to a power source when the electronics device may be performing a set of tasks, or may include test results for an electronics device that may have specific components or circuitry. The power consumption characteristics may be stored and accessed from a database or other indexed storage for this purpose or may be obtained from a manufacturer or other vendor, e.g., manufacturer website or promotional materials.

At 204, the power consumption characteristics may be used by the power verification module 150 to generate a test power load. The test power load may be a physical entity, where physical components may be programmed to load a power source according to the obtained characteristics and simulate a power supply, that may be plugged into a power source. Alternatively, virtual modelling techniques may be used to create a test power load that may be applied to a power source, as described below.

In an embodiment, a supervised machine learning model may be trained to predict power supply electrical characteristics using the test results or known information about the power supply, e.g., its components and circuit diagram, and generate the test power load based on the predicted electrical characteristics. One or more of the following machine learning algorithms may be used: logistic regression, naive Bayes, support vector machines, deep neural networks, random forest, decision tree, gradient-boosted tree, multilayer perceptron. One of ordinary skill in the art will recognize that this is a non-limiting list of algorithms that may be used at this step. In an embodiment, an ensemble machine learning technique may be employed that uses multiple machine learning algorithms together to assure better classification when compared with the classification of a single machine learning algorithm. In this embodiment, training data for the model may comprise data sheets or schematics of components or assembled power supplies and may also include test results from a specific power supply, either as part of a test suite for an electronics device or from multiple power supplies with known components or the same schematic over a longer period of time. The results may be stored in a database so that the data is most current, and the output would always be up to date.

In such an embodiment, there may be a feedback mechanism that may display the test power load, or the characteristics of the test power load, to a user, where the user may review the test power load and, based on user interactions including but not limited to clicking a box on a computer screen or making a selection in some way, validate the results of the model and refine the machine learning accordingly.

At 206, the power verification module 150 may identify a power source for test and apply the test power load to the power source. The identification may be accomplished through a regular test procedure of a facility or may be a specific request of a user, though one of ordinary skill in the art will recognize that there are many possible ways of identifying a power source for test. In addition, in a facility with many power sources available, more than one power source may be identified at this step, with the goal of determining separability among power sources, which may be important in facilities with high availability metrics. Application of the test power load may be accomplished by plugging in test equipment or the test power load directly to an identified power source, or may alternatively be done through virtual modelling, where the interaction between the test power load and the power source may be simulated in software and the behavior of the power source may be monitored and analyzed, as described below.

At 208, a connection suitability may be determined for the power source based on a response of the power source to the test power load. The connection suitability may be a classification of the response of the power source to the test power load. For example, the line voltage or frequency response of the power source may be measured with the test power load applied and compared to a known steady state of the power source. Anomalies that may be detected in these measurements could indicate problems such as poor wiring or short circuits that may be present due to faulty equipment in the power distribution system, e.g., bad circuit breakers. If anomalies are detected or suspected, then the power verification module 150 may “set” the connection suitability as not suitable for connection and otherwise, as suitable for connection. Also at this step, the test power load may apply the test power load to both a first power source and a second power source. Based on the response of both power sources, the power verification module 150 may determine if the two power sources are connected to one another or to the same power distribution system. In such a case, the power verification module 150 may “set” the connection suitability for the power sources as not suitable for connection, since the purpose of a separability test would be to maintain high availability and use two separate power sources. It should be noted that either the measurements of a single power source or a determination of separability between two power sources may be used to update the connection suitability of the power source being tested. Examples of electrical power characteristics that may be measured to determine connection suitability and whether multiple power sources may be distinct and separated, may include but are not limited to root mean square (RMS) line voltage, average line voltage, peak-to-peak (P-P) line voltage, line frequency, Total Harmonic Distortion, and frequency content that may be obtained through a Fast Fourier Transform (FFT) or other means.

In an embodiment, a supervised machine learning model may be trained to predict a normal response of the power source to test power load, such that the connection suitability of the power source may be determined based on comparing the response of the power source to the test power load to the normal response. The power verification module 150 may use the comparison to update the connection suitability, where the power source is not suitable if the response to the test power load does not match the determined normal response to the test power load. One or more of the following machine learning algorithms may be used: logistic regression, naive Bayes, support vector machines, deep neural networks, random forest, decision tree, gradient-boosted tree, multilayer perceptron. One of ordinary skill in the art will recognize that this is a non-limiting list of algorithms that may be used at this step. In an embodiment, an ensemble machine learning technique may be employed that uses multiple machine learning algorithms together to assure better classification when compared with the classification of a single machine learning algorithm. In this embodiment, training data for the model may comprise results from prior applications of a load to the power source, in addition to any known information about the test power load that may or may not come from the machine learning model described above or data with respect to the power source. The training data may be collected from a single power source, which may be the power source currently under test or another power source with the same or similar characteristics or may be collected from multiple power sources over a longer period of time. The results may be stored in a database so that the data is most current, and the output would always be up to date.

At 210, the power verification module 150 may display an indication of the connection suitability for the power source. One of ordinary skill in the art may recognize that this display may take several different forms, including but not limited to an indicator light or a message on a screen. In addition to the display, a notification may be transmitted with the indication of the connection suitability. This notification may be sent to a user or other interested party as a text message or email, though the notification may take several forms as well. In a test equipment embodiment, for example, the display and notification may be a simple LED that may illuminate green for a suitable connection and red for a connection that is not suitable. It should also be noted that the notification may be forwarded to the facility for remedial action to be taken and also there may be a feedback mechanism such as what may be available for the test power load, in that a user or other interested party may review the connection suitability and a manual user interaction with the results may be sent that may be used to refine the machine learning models that may be implements as part of the process 200.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for verifying electrical power distribution system suitability, the computer-implemented method comprising:
obtaining power consumption characteristics from a computer server;
generating a test power load based on the power consumption characteristics;
identifying a power source and applying the test power load to the power source;
determining a connection suitability for the power source based on a response of the power source to the test power load; and
displaying the connection suitability for the power source on a device.

2. The computer-implemented method of claim 1, further comprising transmitting a notification of the connection suitability for the power source to a user.

3. The computer-implemented method of claim 1, further comprising:
identifying a second power source and applying the test power load to the second power source;
determining that the power source and the second power source are not connected based on a second response of the second power source to the test power load and the response of the power source to the test power load; and
updating the connection suitability for the power source, wherein the power source is not suitable for connection.

4. The computer-implemented method of claim 1, wherein the generating the test power load uses a machine learning model that predicts electrical characteristics of a power supply based on known information about the power supply.

5. The computer-implemented method of claim 1, further comprising generating a normal response for the power source to the test power load using a machine learning model that predicts electrical characteristics of a power distribution system in response to a power load.

6. The computer-implemented method of claim 5, further comprising:
detecting that the normal response for the power source to the test power load does not match the response of the power source to the test power load; and
updating the connection suitability for the power source, wherein the power source is not suitable for connection.

7. The computer-implemented method of claim 1, further comprising:
displaying a model of the test power load to a user;
monitoring user interactions with the model of the test power load; and
updating the test power load based on the user interactions.

8. A computer system for verifying electrical power distribution system suitability, the computer system comprising:
one or more processors, one or more computer-readable memories, and one or more computer-readable storage media;
program instructions, stored on at least one of the one or more computer-readable storage media for execution by at least one of the one or more processors via at least one of the one or more computer-readable memories, to obtain power consumption characteristics from a computer server;
program instructions, stored on at least one of the one or more computer-readable storage media for execution by at least one of the one or more processors via at least one of the one or more computer-readable memories, to generate a test power load based on the power consumption characteristics;
program instructions, stored on at least one of the one or more computer-readable storage media for execution by at least one of the one or more processors via at least one of the one or more computer-readable memories, to identify a power source and apply the test power load to the power source;
program instructions, stored on at least one of the one or more computer-readable storage media for execution by at least one of the one or more processors via at least one of the one or more computer-readable memories, to determine a connection suitability for the power source based on a response of the power source to the test power load; and
program instructions, stored on at least one of the one or more computer-readable storage media for execution by at least one of the one or more processors via at least one of the one or more computer-readable memories, to display the connection suitability for the power source on a device.

9. The computer system of claim 8, further comprising: program instructions, stored on at least one of the one or more computer-readable storage media for execution by at least one of the one or more processors via at least one of the one or more computer-readable memories, to transmit a notification of the connection suitability for the power source to a user.

10. The computer system of claim 8, further comprising:
program instructions, stored on at least one of the one or more computer-readable storage media for execution by at least one of the one or more processors via at least one of the one or more computer-readable memories, to identify a second power source and applying the test power load to the second power source;
program instructions, stored on at least one of the one or more computer-readable storage media for execution by at least one of the one or more processors via at least one of the one or more computer-readable memories, to determine that the power source and the second power source are not connected based on a second response of the second power source to the test power load and the response of the power source to the test power load; and
program instructions, stored on at least one of the one or more computer-readable storage media for execution by at least one of the one or more processors via at least one of the one or more computer-readable memories, to update the connection suitability for the power source, wherein the power source is not suitable for connection.

11. The computer system of claim 8, wherein the program instructions, stored on at least one of the one or more computer-readable storage media for execution by at least one of the one or more processors via at least one of the one or more computer-readable memories, to generate the test power load use a machine learning model that predicts electrical characteristics of a power supply based on known information about the power supply.

12. The computer system of claim 8, further comprising program instructions, stored on at least one of the one or more computer-readable storage media for execution by at least one of the one or more processors via at least one of the one or more computer-readable memories, to generate a normal response for the power source to the test power load using a machine learning model that predicts electrical characteristics of a power distribution system in response to a power load.

13. The computer system of claim 12, further comprising:
program instructions, stored on at least one of the one or more computer-readable storage media for execution by at least one of the one or more processors via at least one of the one or more computer-readable memories, to detect that the normal response for the power source to the test power load does not match the response of the power source to the test power load; and
program instructions, stored on at least one of the one or more computer-readable storage media for execution by at least one of the one or more processors via at least one of the one or more computer-readable memories, to update the connection suitability for the power source, wherein the power source is not suitable for connection.

14. The computer system of claim 8, further comprising:
program instructions, stored on at least one of the one or more computer-readable storage media for execution by at least one of the one or more processors via at least one of the one or more computer-readable memories, to display a model of the test power load to a user;
program instructions, stored on at least one of the one or more computer-readable storage media for execution by at least one of the one or more processors via at least one of the one or more computer-readable memories, to monitor user interactions with the model of the test power load; and
program instructions, stored on at least one of the one or more computer-readable storage media for execution by at least one of the one or more processors via at least one of the one or more computer-readable memories, to update the test power load based on the user interactions.

15. A computer program product for verifying electrical power distribution system suitability, the computer program product comprising:
one or more computer-readable storage media;
program instructions, stored on at least one of the one or more computer-readable storage media, to obtain power consumption characteristics from a computer server;
program instructions, stored on at least one of the one or more computer-readable storage media, to generate a test power load based on the power consumption characteristics;
program instructions, stored on at least one of the one or more computer-readable storage media, to identify a power source and apply the test power load to the power source;
program instructions, stored on at least one of the one or more computer-readable storage media, to determine a connection suitability for the power source based on a response of the power source to the test power load; and
program instructions, stored on at least one of the one or more computer-readable storage media, to display the connection suitability for the power source on a device.

16. The computer program product of claim 15, further comprising program instructions, stored on at least one of the one or more computer-readable storage media, to transmit a notification of the connection suitability for the power source to a user.

17. The computer program product of claim 15, further comprising:
program instructions, stored on at least one of the one or more computer-readable storage media, to identify a second power source and applying the test power load to the second power source;
program instructions, stored on at least one of the one or more computer-readable storage media, to determine that the power source and the second power source are not connected based on a second response of the second power source to the test power load and the response of the power source to the test power load; and
program instructions, stored on at least one of the one or more computer-readable storage media, to update the connection suitability for the power source, wherein the power source is not suitable for connection.

18. The computer program product of claim 15, wherein the program instructions, stored on at least one of the one or more computer-readable storage media, to generate the test power load use a machine learning model that predicts electrical characteristics of a power supply based on known information about the power supply.

19. The computer program product of claim 15, further comprising program instructions, stored on at least one of the one or more computer-readable storage media, to generate a normal response for the power source to the test power load using a machine learning model that predicts electrical characteristics of a power distribution system in response to a power load.

20. The computer program product of claim 19, further comprising:
program instructions, stored on at least one of the one or more computer-readable storage media, to detect that the normal response for the power source to the test power load does not match the response of the power source to the test power load; and
program instructions, stored on at least one of the one or more computer-readable storage media, to update the connection suitability for the power source, wherein the power source is not suitable for connection.
